(19) United States
(12) Patent Application Publication
(10) Pub. No.: US 2026/0197135 A1
(43) Pub. Date: Jul. 9, 2026

(54) UE-INITIATED/EVENT-DRIVEN BEAM MEASUREMENT AND REPORTING PROCEDURES

(71) Applicant: Samsung Electronics Co., Ltd., Suwon-si (KR)

(72) Inventors: Dalin Zhu, Allen, TX (US); Eko Onggosanusi, Coppell, TX (US)

(21) Appl. No.: 19/425,404

(22) Filed: Dec. 18, 2025

Related U.S. Application Data
(60) Provisional application No. 63/743,129, filed on Jan. 8, 2025.

(51) Int. Cl. H04L 5/00; H04W 72/21; H04W 72/232

(52) U.S. Cl. CPC H04L 5/0048; H04L 5/0053; H04L 5/0091; H04W 72/21; H04W 72/232

(57) ABSTRACT

Methods and apparatuses for user equipment (UE)-initiated/event-driven beam measurement and reporting procedures. A method performed by a user equipment (UE) includes receiving a first transmission configuration indication (TCI) state and a second TCI state, receiving configurations of a first candidate reference signal (RS) and a second candidate RS, and receiving a first indicator. The method further includes determining a first current RS associated with the first TCI state and a second current RS associated with the second TCI state, determining, based on the first indicator, a first subset of the first and second current RSs and a second subset of the first and second candidate RSs, determining an event based on the first and second subsets, and transmitting a second indicator related to the event.

### CROSS-REFERENCE TO RELATED AND CLAIM OF PRIORITY

The present application claims priority under 35 U.S.C. § 119(e) to U.S. Provisional Patent Application No. 63/743,129 filed on Jan. 8, 2025, which is hereby incorporated by reference in its entirety.

### TECHNICAL FIELD

The present disclosure relates generally to wireless communication systems and, more specifically, the present disclosure relates to methods and apparatuses for user equipment (UE)-initiated/event-driven beam measurement and reporting procedures.

### BACKGROUND

Wireless communication has been one of the most successful innovations in modem history.

Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UE-initiated/event-driven beam measurement and reporting procedures.

In one embodiment, a user equipment (UE) is provided. The UE includes a transceiver configured to receive a first transmission configuration indication (TCI) state and a second TCI state, receive configurations of a first candidate reference signal (RS) and a second candidate RS, and receive a first indicator. The UE further includes a processor operably coupled with the transceiver. The processor is configured to determine a first current RS associated with the first TCI state and a second current RS associated with the second TCI state, determine, based on the first indicator, a first subset of the first and second current RSs and a second subset of the first and second candidate RSs, and determine an event based on the first and second subsets. The transceiver is further configured to transmit a second indicator related to the event.

In another embodiment, a base station (BS) is provided. The BS includes a processor and a transceiver operably coupled with the processor. The transceiver is configured to transmit a first TCI state and a second TCI state, where a first current RS is associated with the first TCI state and a second current RS is associated with the second TCI state and transmit configurations of a first candidate RS and a second candidate RS. The transceiver is further configured to transmit a first indicator, where the first indicator indicates a first subset of the first and second current RSs and a second subset of the first and second candidate RSs, and receive a second indicator related to an event, where the event is based on the first and second subsets.

In yet another embodiment, a method performed by a UE is provided. The method includes receiving a first TCI state and a second TCI state, receiving configurations of a first candidate RS and a second candidate RS, and receiving a first indicator. The method further includes determining a first current RS associated with the first TCI state and a second current RS associated with the second TCI state, determining, based on the first indicator, a first subset of the first and second current RSs and a second subset of the first and second candidate RSs, determining an event based on the first and second subsets, and transmitting a second indicator related to the event.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure; and

FIG. 7 illustrates an example method performed by a UE in a wireless communication system according to embodiments of the present disclosure.

### DETAILED DESCRIPTION

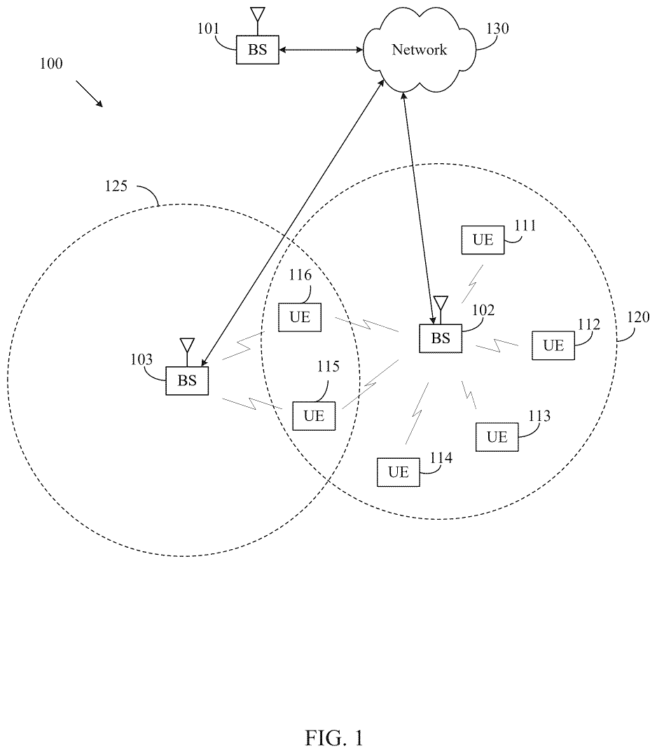

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1]3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. Forthe sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing UE-initiated/event-driven beam measurement and reporting procedures. In certain embodiments, one or more of the BSs 101-103 include circuitry, programing, or a combination thereof to support UE-initiated/event-driven beam measurement and reporting procedures.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

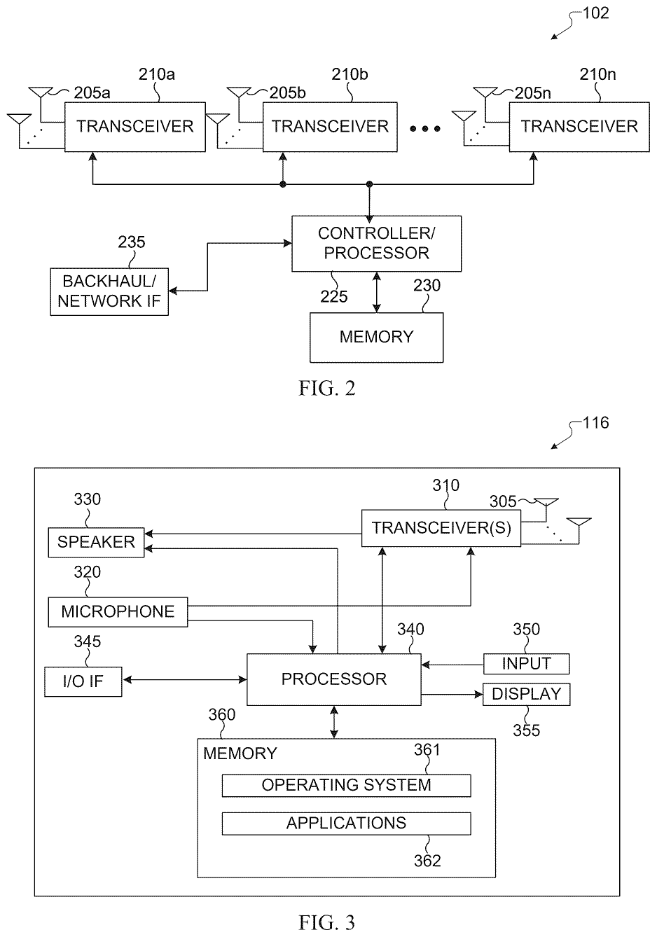

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting UE-initiated/event-driven beam measurement and reporting procedures. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize UE-initiated/event-driven beam measurement and reporting procedures as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

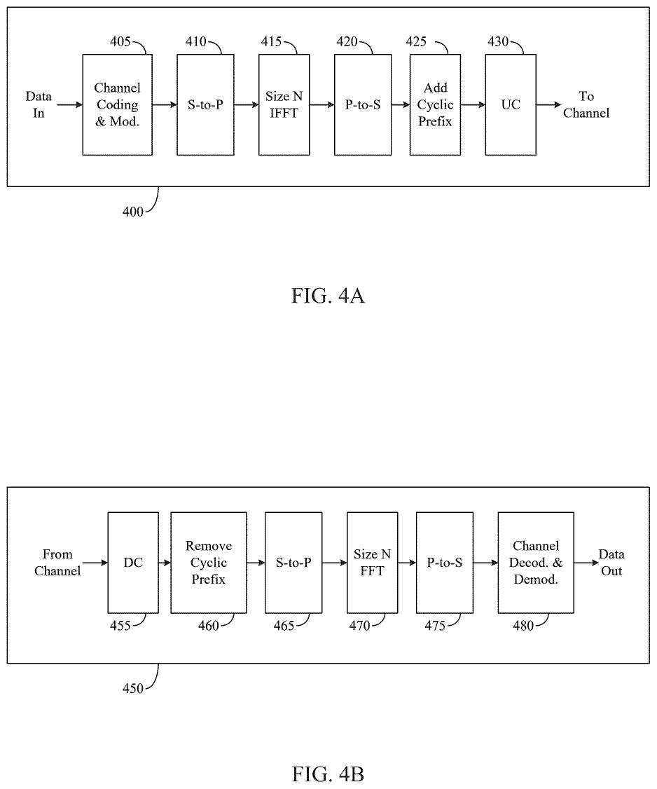

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support UE-initiated/event-driven beam measurement and reporting procedures as described in embodiments of the present disclosure. In some embodiments, the receive path 450 is configured to support UE) reporting triggered beam switching as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

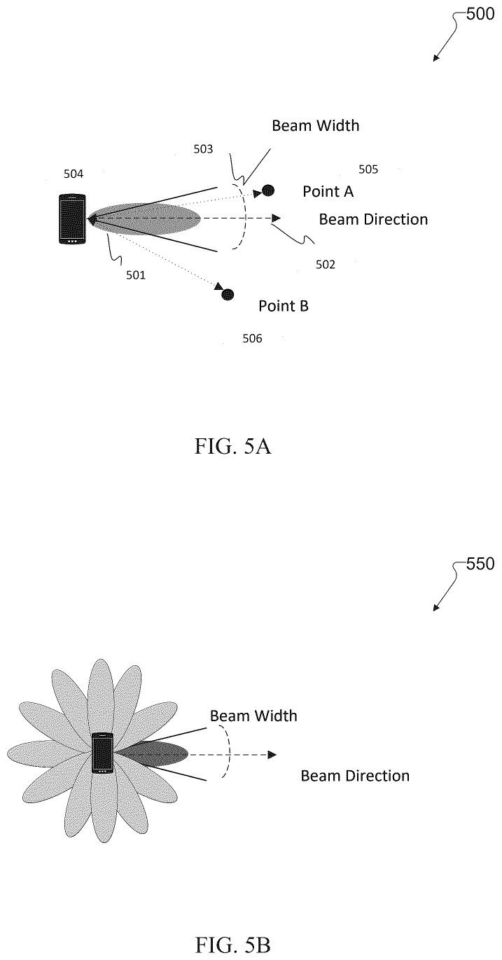

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

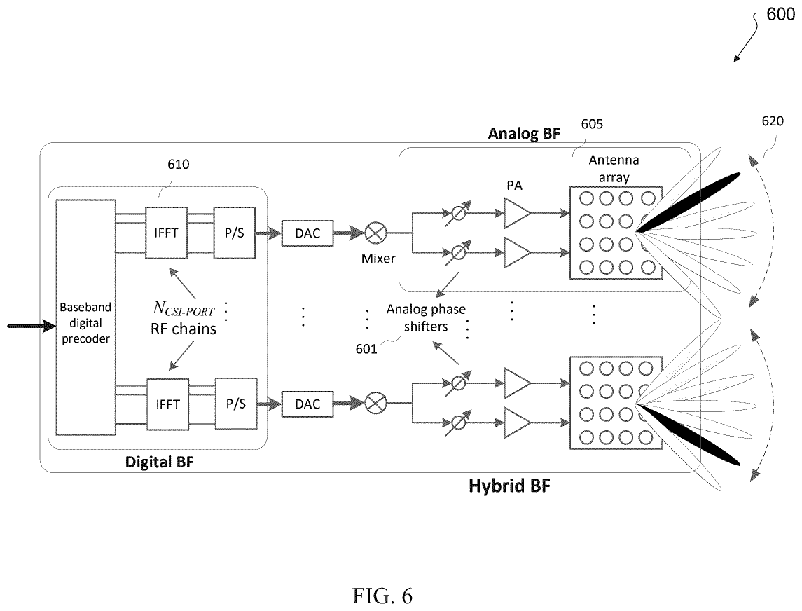

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are needed to compensate for the additional path loss.

In this disclosure, a beam is determined by either of,
A transmission configuration indication (TCI) state, that establishes a quasi-colocation (QCL) relationship between a source reference signal (e.g., synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that in (up to Rel.17) the NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), and/or multiple event types when a report type can be associated with an event (e.g., for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various resource allocation and association methods to enable the UE-initiated/event-driven beam reporting as well. Furthermore, the present disclosure provides various design aspects and therefore corresponding solutions for the case(s) where the UE receives the network's response(s) during the UE-initiated/event-driven beam operation/management process. Both single-TRP and multi-TRP based operations are target application scenarios of the present disclosure.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘II’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g., NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g., channel quality indicator (CQI) report interval (CRI), SSB resource indicator (SSBRI)) and Jᵢ is a beam metric (e.g., L1-reference signal received power (RSRP), L1-signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g., Doppler spread or Doppler shift, relative Doppler spreads, or relative Doppler shifts), or an indicator about the auto-correlation profiles (e.g., (auto-)correlation values corresponding to a few dominant lags/delays).
In one example, the content includes other (e.g., non-beam, non-CSI, non-TDCP) quantity/quantities.
   In one example, quantity/quantities comprises a selector/indicator indicating selection of one (or >1) of either
      beam (TCI state) TCI states (e.g., DL TCI state, UL TCI state, or unified (joint) DL/UL TCI state), or
      panel(s) (e.g., UE panels for DL reception or/and UL transmission), or
      antenna(e) (e.g., UE antennae for DL reception or/and UL transmission), or
      antenna port(s) (e.g., UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁*N₂ (e.g., this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the UE is a Uu interface (i.e., DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e., without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-basedor event-based, based on report-type.

In one example, such reporting can be non-event-basedor event-based, based on a configuration.

A few examples of (the event-types andthe report-types are provided in Table 1 (forjoint) and Table 2/Table 3 (for separate). In these examples, the event-types and the report-types are separate (explicit). However, they can also be Joint, as shown in Table 4. A few examples of the autonomous UE-initiated report are shown in Table 5.

TABLE 1
event-based UE-initiated report

| | Report | | |
|---|---|---|---|
| | | Trigger/pre-notification | |
| Event type | Type | message | Content |
| 0: beam | (A) | Yes (e.g., beam-related event) | No |
| | (B) | No | Yes |
| | (C) | Yes (e.g., beam-related event) | Yes |
| 1: CSI | (A) | Yes (e.g., CSI-related event) | No |
| | (B) | No | Yes |
| | (C) | Yes (e.g., CSI-related event) | Yes |
| 2: TDCP | (A) | Yes (e.g., TDCP-related event) | No |
| | (B) | No | Yes |
| | (C) | Yes (e.g., TDCP-related event) | Yes |
| 3: non-CSI/ | (A) | Yes (e.g., non-CSI-related event) | No |
| beam/TDCP | (B) | No | Yes |
| | (C) | Yes (e.g., non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g., beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g., CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g., from Type I to Type II or vice versa), or rank restriction (e.g., from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g., CR-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g., MCS, or number of CWs.
For another example, when there is no pre-notification message/trigger associated with a content, i.e., the report-type is (B), the content can be transmitted using UL resource(s) configured (e.g., configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) atransmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based LI signaling(s), based on/according to a corresponding UE's capability reporting: for example, the UE could receive from the network, e.g., via higher layer RRC signaling(s)/parameter(s) and/or MAC CE command(s) and/or dynamic DCI based LI signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 10, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 00, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein all of the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, all of the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCJ-StateList and is having two indicated TCI-states, if the UE does not report its capability indicating support of “two default beams for S-DCI basedMTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCJ-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beamsfor S-DCI basedMTRP” in frequency range 2 and if the scheduling offset between the reception of the scheduling DCI format 1_0/1_1/1_2 and the scheduled/activated PDSCH reception is equal to or larger than timeDurationForQCL
The UE can be configured by higher layer parameter applyIndicatedTClState to indicate whether the first, the second, or both of the indicated TCI-state(s) is/are applied to PDSCH reception scheduled or activated by DCI format 1_0. The UE can be configured with applyIndicatedTClState with value both only when the UE is configured with cjtSchemePDSCH and the UE reports its capability indicating support of two joint TCI statesfor PDSCH-CJT or the UE is configured with sfnSchemePdsch. In that case, the UE shall apply both indicated TCI-states to PDSCH reception scheduled or activated by DCI format 1_0 on a search space other than Type/0A/2 CSS on CORESET #0.
If the UE is not configured with applyIndicatedTClState, the first indicated TCI-state is applied to PDSCH reception scheduled or activated by DCI format 1_0.
When the UE is configured with tciSelection-PresentinDCIjointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to all PDSCH DM-RS port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to all PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting athird indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

The RS(s) or RS resource(s) or RS resource index(es) of/for a current serving beam—denoted by current serving beam RS(s) or RS resource(s) or RS resource index(es)—could be identified or determined according to or based on one or more network's responses (NWRs), if applicable (i.e., the current serving beam RS(s) or RS resource(s) or RS resource index(es) could be associated or corresponding or linked or mapped to the NWR(s) if applicable) according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the indicated TCI state could be regarded/referred to as a NWR.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the indicated TCI state could be regarded/referred to as a NWR.
(explicit configuration example-1): a set so of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set so of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure. For this design example, the set so provided by currentServBeamRSList could be regarded/referred to as a NWR.
(explicit configuration example-2): a set so of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set so of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure. For this design example, the set so provided by currentServBeamRSList could be regarded/referred to as a NWR.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set so of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to or based on one or more NWRs, if applicable (i.e., the (candidate/actual) candidate/new beam RS(s) or RS resource(s) or RS resource index(es) could be associated or corresponding or linked or mapped to the NWR(s) if applicable) according to one or more of:
(explicit configuration example-A): a set s₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by CandidateBeamRSList could be regarded/referred to as a NWR.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by CandidateBeamRSList could be regarded/referred to as a NWR.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more activated TCI states could be regarded/referred to as NWR(s).
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more activated TCI states could be regarded/referred to as NWR(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more configured/provided TCI states could be regarded/referred to as NWR(s).
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more configured/provided TCI states could be regarded/referred to as NWR(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource index(es)—could be identified or determined according to or based on one or more NWRs, if applicable (i.e., the activation beam RS(s) or RS resource(s) or RS resource index(es) could be associated or corresponding or linked or mapped to the NWR(s) if applicable) according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the activated TCI state could be regarded/referred to as a NWR.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the activated TCI state could be regarded/referred to as a NWR.
(explicit configuration example-i): a set \vec{s}₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₂ provided by activationBeamRSList could be regarded/referred to as a NWR.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₂ provided by activationBeamRSList could be regarded/referred to as a NWR.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc. Throughout the present disclosure, according to or following those specified or defined herein in the present disclosure, an indicated TCI state, an activation TCI state or a provided/configured TCI state could be regarded/referred to as a NWR, or a NWR could be in form of an indicated TCI state, an activation TCI state or a provided/configured TCI state as specified/defined herein in the present disclosure. Furthermore, according to or following those specified or defined herein in the present disclosure, a UE could determine or identify or derive measurement RS(s) or RS resource(s)—e.g., the current serving beam RS(s) or RS resource(s) or RS resource index(es) and/or the (candidate/actual) candidate/new beam RS(s) or RS resource(s) or RS resource index(es) and/or the activation beam RS(s) or RS resource(s) or RS resource index(es) as specified/defined herein in the present disclosure—for evaluating, assessing, detecting, declaring or determining the event(s) and/or event instance(s) as specified/defined herein in the present disclosure from or based on or according to one or more NWRs.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and/or the UE has stored QCL properties of the determined or identified at least one (same) candidate/new beam or candidate/new beam RS/RS resource, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states (or one or more NWRs in general) or one or more activation beam RSs/RS resources as specified/defined herein in the present disclosure; and/or the UE has stored QCL properties of the determined or identified at least one (same) candidate/new beam or candidate/new beam RS/RS resource, furthermore, e.g., when/if the NWR(s) corresponds to or is in form of one or more activated beams/TCI states, the UE could determine or identify the one or more activated beams/TCI states as or corresponding to the activated beam/TCI state among all the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as L1-RSRP(s)/L1-SINR(s) among all the activation beam RSs or RS resources corresponding, specific or associated to all the activated beams/TCI states in the (unified) TCI state(s) activation/deactivation MAC CE command according to or following those specified herein in the present disclosure. Here, the UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fourth event (or an Event-4 instance) according to or based on or corresponding to: the UE could determine or identify at least one (same) candidate/new beam or candidate/new beam RS/RS resource that has a beam quality/metric (e.g., a measured L1-RSRP/L1-SINR) greater than or equal to a threshold, and/or the UE has stored QCL properties of the determined or identified at least one (same) candidate/new beam or candidate/new beam RS/RS resource, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fifth event (or an Event-5 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured L1-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and/or the UE has stored QCL properties of the determined or identified at least one (same) candidate/new beam or candidate/new beam RS/RS resource, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a sixth event (or an Event-6 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured L1-RSRP/L1-SINR) greater than or equal to a second threshold, and/or the UE has stored QCL properties of the determined or identified at least one (same) candidate/new beam or candidate/new beam RS/RS resource, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a seventh event (or an Event-7 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, (2) at least one (same) candidate/new beam or candidate/new beam RS/RS resource that has a beam quality/metric (e.g., a measured L1-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and (3) at least one (same) candidate/new beam or candidate/new beam RS/RS resource that has a beam quality/metric (e.g., a measured L1-RSRP/L1-SINR) greater than or equal to a third threshold, and/or the UE has stored QCL properties of the determined or identified at least one (same) candidate/new beam or candidate/new beam RS/RS resource, wherein the UE could determine or identify the first, second and/or third threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and the at least one (same) candidate/new beam or candidate/new beam RS/RS resource determined or identified in (2) could be identical to or same as the at least one (same) candidate/new beam or candidate/new beam RS/RS resource determined or identified in (3).

Throughout the present disclosure, when/if a UE has stored QCL properties of a RS or RS resource,
when/if the RS or RS resource is an SSB, the UE could have stored QCL properties of the SSB
when/if the RS or RS resource is an NZP CSI-RS, the UE could have stored QCL properties of SSB(s) that is QCL'ed—e.g. of QCL-TypeD—with the NZP CSI-RS
when/if the RS or RS resource is an NZP CSI-RS, the UE could have stored QCL properties of the NZP CSI-RS.

A UE could be provided or configured or indicated by the network, e.g., via/by/in higher layer RRC signaling(s)/parameter(s) including CSI-ReportConfig and/or UEI-ReportConfig that provides or configures necessary information and/or setting(s) for the UE-initiated/event-driven beam operations including beam(s) reporting, beam(s) switching/update, etc. as specified/defined herein in the present disclosure and/or MAC CE command(s) and/or dynamic DCI based L1 signaling(s) according to or based on corresponding UE's capability(s) or capability signaling(s), one or more indicators/parameters to enable one or more of the Event-1, Event-2, Event-3, Event-4, Event-5, Event-6 and Event-7 as specified/defined herein in the present disclosure. For instance, the UE could be provided or configured with a higher layer parameter eventType set to:
‘event-1’ to enable the Event-1
‘event-2’ to enable the Event-2
‘event-3’ to enable the Event-3
‘event-4’ to enable the Event-4
‘event-5’ to enable the Event-5
‘event-6’ to enable the Event-6
‘event-7’ to enable the Event-7
‘event-x-y’ to enable both the Event-x and Event-y, wherein x={1, . . . , 7}, y={1, . . . , 7}, and x*y
‘event-x-y-z’ to enable the Event-x, Event-y and Event-z, wherein x={1, . . . , 7}, y={1, . . . , 7}, z={1, . . . , 7}, and x*y*z.

The corresponding UE's capability(s) or capability signaling(s) could comprise one or more of the following components:
‘event-1’- to indicate their support of Event-1
‘event-2’- to indicate their support of Event-2
‘event-3’- to indicate their support of Event-3
‘event-4’- to indicate their support of Event-4
‘event-5’- to indicate their support of Event-5
‘event-6’- to indicate their support of Event-6
‘event-7’- to indicate their support of Event-7
‘event-x-y’- to indicate their support of Event-x and Event-y, wherein x={1, . . . , 7}, y={1, . . . , 7}, and x*y
‘event-x-y-z’ to—to indicate their support of Event-x, Event-y and Event-z, wherein x={1, . . . , 7}, y={1, . . . , 7}, z={1, . . . , 7}, and x*y*z.

According to or following those specified/defined herein in the present disclosure,
when/if an Event-x (wherein x={1, . . . , 7}) is enabled, (higher layer(s) of) a UE could determine, detect or declare the Event-x when/if (higher layer(s) of) the UE has determined or identified that the number of instance(s) of the x-th event (or equivalently, the number of the Event-x instance(s)) is greater than or equal to numberOfEventInstances 1 (higher layer configured) within a time window having a length/duration of timeWindowDuration (higher layer configured);
when/if an Event-x and an Event-y (wherein x={1, . . . , 7}, y={1, . . . , 7}, and x*y) are enabled, (higher layer(s)) of a UE could determine, detect or declare both of the Event-x and Event-y when/if (higher layer(s) of) the UE has determined or identified that (1):
   the number of instance(s) of the x-th event (or equivalently, the number of the Event-x instance(s)) is greater than or equal to numberOfEventxInstances 1 (higher layer configured) within a first time window having a length/duration of timeWindowIDuration (higher layer configured), and
   the number of instance(s) of the y-th event (or equivalently, the number of the Event-y instance(s)) is greater than or equal to numberOfEventyInstances 1 (higher layer configured) within a second time window having a length/duration of timeWindow2Duration (higher layer configured),
      wherein the first symbol/slot/etc. of the first time window and the first symbol/slot/etc. of the second time window are expected to be later in time than the first symbol/slot/etc. of an overall time window having a length/duration of timeWindowDuration (higher layer configured), and the last symbol/slot/etc. of the first time window and the last symbol/slot/etc. of the second time window are expected to be earlier in time than the last symbol/slot/etc. of the overall time window; or (2): the number of instance(s) of the x-th event (or equivalently, the number of the Event-x instance(s)) is greater than or equal to numberOfEventxInstances≥1 (higher layer configured) and the number of instance(s) of the y-th event (or equivalently, the number of the Event-y instance(s)) is greater than or equal to numberOfEventyInstances≥1 (higher layer configured) within a time window having a length/duration of timeWindowDuration (higher layer configured); in this case, when/if the determination, detection or declaration of each of the Event-x and Event-y (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x and Event-y.
when/if an Event-x, an Event-y and an Event-z (wherein x={1, . . . , 7}, y={1, . . . , 7}, z={1, . . . , 7}, and x≠y≠z) are enabled, (higher layer(s)) of a UE could determine, detect or declare both of the Event-x, Event-y and Event-z when/if (higher layer(s) of) the UE has determined or identified that (1):
   the number of instance(s) of the x-th event (or equivalently, the number of the Event-x instance(s)) is greater than or equal to numberOfEventxInstances 1 (higher layer configured) within a first time window having a length/duration of timeWindowIDuration (higher layer configured), and
   the number of instance(s) of the y-th event (or equivalently, the number of the Event-y instance(s)) is greater than or equal to numberOfEventyInstances 1 (higher layer configured) within a second time window having a length/duration of timeWindow2Duration (higher layer configured), and
   the number of instance(s) of the z-th event (or equivalently, the number of the Event-z instance(s)) is greater than or equal to numberOfEventzInstances 1 (higher layer configured) within a third time window having a length/duration of timeWindow3Duration (higher layer configured),
      wherein the first symbol/slot/etc. of the first time window, the first symbol/slot/etc. of the second time window and the first symbol/slot/etc. of the third time window are expected to be later in time than the first symbol/slot/etc. of an overall time window having a length/duration of timeWindowDuration (higher layer configured), and the last symbol/slot/etc. of the first time window, the last symbol/slot/etc. of the second time window and the last symbol/slot/etc. of the third time window are expected to be earlier in time than the last symbol/slot/etc. of the overall time window; or (2): the number of instance(s) of the x-th event (or equivalently, the number of the Event-x instance(s)) is greater than or equal to numberOfEventxInstances 1 (higher layer configured), the number of instance(s) of the y-th event (or equivalently, the number of the Event-y instance(s)) is greater than or equal to numberOfEventyInstances 1 (higher layer configured) and the number of instance(s) of the z-th event (or equivalently, the number of the Event-z instance(s)) is greater than or equal to numberOfEventzInstances 1 (higher layer configured) within a time window having a length/duration of timeWindowDuration (higher layer configured); in this case, when/if the determination, detection or declaration of each of the Event-x, Event-y and Event-z (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x, Event-y and Event-z.

As specified/defined in later part(s)/section(s) of the present disclosure, a UE could determine or identify the first and/or last symbol(s)/slot(s)/etc. of a time window for evaluating and/or assessing instance(s) of the event(s) and/or to detect, declare and/or determine the event(s) according to or following those specified herein in the present disclosure with a reference to or with respect to or according to transmission or transmission occasion of a PUCCH of a/the first UL channel as in Step-1 for Mode A, Mode B and/or Mode C as specified/defined herein in the present disclosure.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to or based on one or more NWRs, if applicable (i.e., the current serving beam RS(s) or RS resource(s) or RS resource index(es) could be associated or corresponding or linked or mapped to the NWR(s) if applicable) according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-1 and/or Scheme-2, the indicated TCI state could be regarded/referred to as a NWR, or a NWR could correspond to or could be in form of the indicated TCI state.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be regarded/referred to as NWR(s) as well (or a NWR could be in form of configuration of the set of candidate/new beam RS(s)/RS resource(s)) and provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

For a NWR in form of an activated TCI state—e.g., a joint/DL TCI state, a UE could determine or identify RS(s) or RS resource(s) or RS resource index(es) of/for the activated TCI state (or in general, the NWR)—denoted by activation beam RS(s) or RS resource(s) or RS resource index(es) e.g. associated or corresponding or linked or mapped to the NWR in general if applicable—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-A and/or Scheme-B, the activated TCI state could be regarded/referred to as a NWR, or a NWR could correspond to or could be in form of the activated TCI state.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set ofNZP CSI-RS resources provided by NZP-CSI-RS-Resource Set (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS)—or associated or linked or corresponding or mapped to a NWR in general (if applicable), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS)—or associated or linked or corresponding or mapped to a NWR in general (if applicable), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network such that the higher layer parameter e.g. currentBeamRStype is set to ‘CSI-RS’.

According to or following those specified or defined herein in the present disclosure, for a single-DCI based multi-TRP system, a UE could maintain or track or use or apply a first TCI state and/or a second TCI state for transmitting and/or receiving various channels and/or signals to and/or from one or more TRPs according to or following those specified herein in the present disclosure, wherein the first TCI state could correspond to a joint/DL TCI state and the second TCI state could also correspond to a joint/DL TCI state. In particular,
In one example, the first and second TCI states could be indicated or provided by/in a same TCI codepoint (e.g., by/in a (unified) TCI state(s) activation/deactivation MAC CE command and/or of a TCI field in a beam indication DCI for DCI format(s) 1_1/1_2 with or without DL assignment)
In another example, the first and second TCI states could be indicated or provided by/in separate TCI codepoints
   For example, the UE could use or apply or maintain or track at least the first TCI state in the first place (e.g., indicated or provided by/in a TCI codepoint by/in a first (unified) TCI state(s) activation/deactivation MAC CE command and/or of a TCI field in a first beam indication DCI for DCI format(s) 1_1/1_2 with or without DL assignment) for transmitting and/or receiving various channels and/or signals to and/or from one or more TRPs; the UE could then receive from the network the second TCI state (e.g., indicated or provided by/in a TCI codepoint by/in a second (unified) TCI state(s) activation/deactivation MAC CE command and/or of a TCI field in a second beam indication DCI for DCI format(s) 1_1/1_2 with or without DL assignment); in this case, when/if the second TCI state has become applicable, the UE could maintain or track or use or apply both the first and second TCI states for transmitting and/or receiving various channels and/or signals to and/or from one or more TRPs according to or following those specified herein in the present disclosure, wherein the second (unified) TCI state(s) activation/deactivation MAC CE command and/or the second beam indication DCI could be received later in time or could become applicable later in time than the first (unified) TCI state(s) activation/deactivation MAC CE command and/or the first beam indication DCI.
   For another example, the UE could use or apply or maintain or track at least the second TCI state in the first place (e.g., indicated or provided by/in a TCI codepoint by/in a first (unified) TCI state(s) activation/deactivation MAC CE command and/or of a TCI field in a first beam indication DCI for DCI format(s) 1_1/1_2 with or without DL assignment) for transmitting and/or receiving various channels and/or signals to and/or from one or more TRPs; the UE could then receive from the network the first TCI state (e.g., indicated or provided by/in a TCI codepoint by/in a second (unified) TCI state(s) activation/deactivation MAC CE command and/or of a TCI field in a second beam indication DCI for DCI format(s) 1_1/1_2 with or without DL assignment); in this case, when/if the first TCI state has become applicable, the UE could maintain or track or use or apply both the first and second TCI states for transmitting and/or receiving various channels and/or signals to and/or from one or more TRPs according to or following those specified herein in the present disclosure, wherein the second (unified) TCI state(s) activation/deactivation MAC CE command and/or the second beam indication DCI could be received later in time or could become applicable later in time than the first (unified) TCI state(s) activation/deactivation MAC CE command and/or the first beam indication DCI.

Throughout the present disclosure, the first TCI state could be equivalent to or could be referred to as or could correspond to a/the indicated first TCI state or a/the first indicated TCI state, and the second TCI state could be equivalent to or could be referred to as or could correspond to a/the indicated second TCI state or a/the second indicated TCI state.

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, for evaluating, determining, declaring, assessing or detecting one or more events, the UE could determine or identify current beam RS(s) or RS resource(s)—e.g., in terms/form the corresponding RS/resource index(es)/ID(s)—according to or based on RS(s) or RS resource(s) specific or associated or corresponding to the first TCI state and/or the second TCI state:
In one example, the UE could determine or identify the current beam RS(s) or RS resource(s)—e.g., in terms/form the corresponding RS/resource index(es)/ID(s)—according to or based on the RS(s) or RS resource(s) specific or associated or corresponding to the first TCI state when/if one or more of the following conditions are achieved, held or satisfied:
   the UE applies or uses the first TCI state to receive or monitor PDCCH candidate(s) in a CORESET; for example, the first indicator as specified/defined herein in the present disclosure, or equivalently, the higher layer parameter applyIndicatedTCl-State in ControlResourceSet is set to ‘first’ for a/the corresponding CORESET; and
   the UE applies or uses the first TCI state to receive or monitor PDSCH; for example, the second indicator as specified/defined herein in the present disclosure, or equivalently, the TCI selection field is present in a/the corresponding DCI format(s) of 1_1/1_2 with or without DL assignment (e.g., when/if the higher layer parameter/signaling tciSelectionPresentInDCJ is provided/configured and/or set to ‘enabled’) and is set to ‘00’; and
   the UE applies or uses the first TCI state to transmit a PUCCH; for example, the third indicator as specified/defined herein in the present disclosure, or equivalently, the higher layer parameter applyIndicatedTCl-State in PUCCH-Resource is set to ‘first’ for the corresponding PUCCH resource; and
   the UE applies or uses the first TCI state to transmit a PUSCH; for example, the fourth indicator as specified/defined herein in the present disclosure, or equivalently, the SRS resource set indicator is present in a/the corresponding DCI format(s) of 0_1/0_2 that schedules the PUSCH and is set to ‘00’; for another example, the higher layer parameter applyIndicatedTCl-State in PUSCH-Config is set to ‘first’ for the corresponding CG-PUSCH transmission(s); for another example, the PUSCH is scheduled by DCI format 0_0; and
   the UE applies or uses the first TCI state to receive CSI-RS(s); and
   the UE applies or uses the first TCI state to transmit SRS(s); and
   the UE is provided or configured or indicated by the network, e.g., via higher layer RRC signaling(s)/parameter(s) e.g. CSI-ReportConfig and/or UEI-ReportConfig that provides or configures necessary information and/or setting(s) for the UE-initiated/event-driven beam management for the multi-TRP operation and/or MAC CE command(s) and/or dynamic DCI based L1 signaling(s) based on or according to corresponding UE's capability(s)/capability signaling(s), one or more indicators (e.g., a one-bit or a two-bit indicator) to enable and/or indicate to the UE to determine or identify the current beam RS(s) or RS resource(s)—e.g., in terms/form the corresponding RS/resource index(es)/ID(s)—according to or based on the RS(s) or RS resource(s) specific or associated or corresponding to the first TCI; and
   regardless of other condition(s), the UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for the multi-TRP operation.
In another example, the UE could determine or identify the current beam RS(s) or RS resource(s)—e.g., in terms/form the corresponding RS/resource index(es)/ID(s)—according to or based on the RS(s) or RS resource(s) specific or associated or corresponding to the second TCI state when/if one or more of the following conditions are achieved, held or satisfied:
   the UE applies or uses the second TCI state to receive or monitor PDCCH candidate(s) in a CORESET; for example, the first indicator as specified/defined herein in the present disclosure, or equivalently, the higher layer parameter applyIndicatedTCl-State in ControlResourceSet is set to ‘second’ for a/the corresponding CORESET; and
   the UE applies or uses the second TCI state to receive or monitor PDSCH; for example, the second indicator as specified/defined herein in the present disclosure, or equivalently, the TCI selection field is present in a/the corresponding DCI format(s) of 1_1/1_2 with or without DL assignment (e.g., when/if the higher layer parameter/signaling tciSelectionPresentInDCJ is provided/configured and/or set to ‘enabled’) and is set to ‘01’; and
   the UE applies or uses the second TCI state to transmit a PUCCH; for example, the third indicator as specified/defined herein in the present disclosure, or equivalently, the higher layer parameter applyIndicatedTCl-State in PUCCH-Resource is set to ‘second’ for the corresponding PUCCH resource; and
   the UE applies or uses the second TCI state to transmit a PUSCH; for example, the fourth indicator as specified/defined herein in the present disclosure, or equivalently, the SRS resource set indicator is present in a/the corresponding DCI format(s) of 0_1/0_2 that schedules the PUSCH and is set to ‘01’; for another example, the higher layer parameter applyIndicatedTCl-State in PUSCH-Config is set to ‘second’ for the corresponding CG-PUSCH transmission(s); and
   the UE applies or uses the second TCI state to receive CSI-RS(s); and
   the UE applies or uses the second TCI state to transmit SRS(s); and
   the UE is provided or configured or indicated by the network, e.g., via higher layer RRC signaling(s)/parameter(s) e.g. CSI-ReportConfig and/or UEI-ReportConfig that provides or configures necessary information and/or setting(s) for the UE-initiated/event-driven beam management for the multi-TRP operation and/or MAC CE command(s) and/or dynamic DCI based L1 signaling(s) based on or according to corresponding UE's capability(s)/capability signaling(s), one or more indicators (e.g., a one-bit or a two-bit indicator) to enable and/or indicate to the UE to determine or identify the current beam RS(s) or RS resource(s)—e.g., in terms/form the corresponding RS/resource index(es)/ID(s)—according to or based on the RS(s) or RS resource(s) specific or associated or corresponding to the second TCI; and
   regardless of other condition(s), the UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for the multi-TRP operation.
In another example, the UE could determine or identify
   (scheme-i): only first current beam RS(s) or RS resource(s)—e.g., in terms/form the corresponding RS/resource index(es)/ID(s)—according to or based on the RS(s) or RS resource(s) specific or associated or corresponding to the first TCI state; or
   (scheme-ii): only second current beam RS(s) or RS resource(s)—e.g., in terms/form the corresponding RS/resource index(es)/ID(s)—according to or based on the RS(s) or RS resource(s) specific or associated or corresponding to the second TCI state; or
   (scheme-iii): both the first and second current beam RSs or RS resources—e.g., in terms/form the corresponding RS/resource indexes/IDs—according to or based on the RSs or RS resources respectively specific or associated or corresponding to the first and second TCI states
when/if one or more of the following conditions are achieved, held or satisfied:
   the UE applies or uses both of the first and second TCI states to receive or monitor PDCCH candidate(s) in a CORESET; for example, the first indicator as specified/defined herein in the present disclosure, or equivalently, the higher layer parameter applyIndicatedTCl-State in ControlResourceSet is set to ‘both’ for a/the corresponding CORESET, and/or PDCCH SFN is enabled (e.g., the higher layer RRC parameter sfnschemePDCCH is configured) in the serving cell for a/the corresponding CORESET; and
   the UE applies or uses both of the first and second TCI states to receive or monitor PDSCH; for example, the second indicator as specified/defined herein in the present disclosure, or equivalently, the TCI selection field is present in a/the corresponding DCI format(s) of 1_1/1_2 with or without DL assignment (e.g., when/if the higher layer parameter/signaling tciSelectionPresentInDCJ is provided/configured and/or set to ‘enabled’) and is set to ‘10’ or ‘11’, and/or the UE is provided or configured with the higher layer RRC parameter sfnSchemePdsch set to either ‘sfnSchemeA’ or ‘sfnSchemeB’; for another example, the TCI selection field is absent from/in a/the corresponding DCI format(s) of 1_1/1_2 with or without DL assignment (e.g., when/if the higher layerparameter/signaling tciSelectionPresentInDCJ is not provided/configured, or is provided/configured but set to ‘disabled’); and
   the UE applies or uses both of the first and second TCI states to transmit PUCCH(s); for example, the third indicator as specified/defined herein in the present disclosure, or equivalently, the higher layer parameter applyIndicatedTCl-State in PUCCH-Resource is set to ‘both’ for the corresponding PUCCH resource(s); and
   the UE applies or uses both of the first and second TCI states to transmit PUSCH(s); for example, the fourth indicator as specified/defined herein in the present disclosure, or equivalently, the SRS resource set indicator is present in a/the corresponding DCI format(s) of 0_1/0_2 that schedules the PUSCH and is set to ‘10’ or ‘11’; for another example, the higher layer parameter applyIndicatedTCI-State in PUSCH-Config is set to ‘both’ for the corresponding CG-PUSCH transmission(s); and
   the UE is provided or configured or indicated by the network, e.g., via higher layer RRC signaling(s)/parameter(s) e.g. CSI-ReportConfig and/or UEI-ReportConfig that provides or configures necessary information and/or setting(s) for the UE-initiated/event-driven beam management for the multi-TRP operation and/or MAC CE command(s) and/or dynamic DCI based L1 signaling(s) based on or according to corresponding UE's capability(s)/capability signaling(s), one or more indicators (e.g., a one-bit or a two-bit indicator) to enable and/or indicate to the UE to determine or identify the current beam RS(s) or RS resource(s)—e.g., in terms/form the corresponding RS/resource index(es)/ID(s)—according to or based on scheme-i, scheme-ii and/or scheme-iii as specified/defined herein in the present disclosure; and
   regardless of other condition(s), the UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for the multi-TRP operation.

Furthermore, the UE could determine or identify which of scheme-i, scheme-ii and scheme-iii to use or follow for determining or identifying the first and/or second current beam RS(s)/RS resource(s) according to or based on:
fixed rule(s) in system specification(s) and/or per RRC (re-)configuration;
network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via/in/by higher layer RRC signaling(s)/parameter(s) CSI-ReportConfig and/or UEI-ReportConfig that provides or configures necessary information and/or setting(s) for the UE-initiated/event-driven beam management including beam reporting for the multi-TRP operation, a higher layer parameter currentBeamRsScheme; for this design example, when/if the higher layer parameter currentBeamRsScheme is set to ‘first’, the UE could use or follow those specified in scheme-i to determine or identify the (first) current beam RS(s)/RS resource(s), when/if the higher layer parameter currentBeamRsScheme is set to ‘second’, the UE could use or follow those specified in scheme-ii to determine or identify the (second) current beam RS(s)/RS resource(s), and/or when/if the higher layer parameter currentBeamRsScheme is set to ‘both’, the UE could use or follow those specified in scheme-iii to determine or identify the (first and second) current beam RSs/RS resources; for another example, the UE could receive from the network, e.g., via/in/by a DCI format, a 2-bit indicator; for this design example, when/if the 2-bit indicator is set to ‘00’ (or ‘01’ or ‘10’ or ‘11’), the UE could use or follow those specified in scheme-i to determine or identify the (first) current beam RS(s)/RS resource(s), when/if the 2-bit indicator is set to ‘01’ (or ‘00’ or ‘10’ or ‘11’), the UE could use or follow those specified in scheme-ii to determine or identify the (second) current beam RS(s)/RS resource(s), and/or when/if the 2-bit indicator is set to ‘10’ or ‘11’ (or ‘00’ or ‘01’), the UE could use or follow those specified in scheme-iii to determine or identify the (first and second) current beam RSs/RS resources; furthermore, the 2-bit indicator could be or could correspond to a new/dedicated DCI field in the corresponding DCI format, or the 2-bit indicator could be realized, signaled and/or implemented in the corresponding DCI format by repurposing one or more codepoints of one or more existing DCI fields in the corresponding DCI format.
UE's implementation, or UE's autonomous determination/selection, which could be further sent or indicated to the network via various UL channels and/or signals, e.g., via/in part of a beam/CSI report or UE's capability signaling(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, and/or when/if for a serving cell the UE is provided two coresetPoolIndex values 0 and 1 for first and second CORESETs, or is not provided coresetPoolIndex value for first CORESETs and is provided coresetPoolIndex value of 1 for second CORESETs, for evaluating, determining, declaring, assessing or detecting one or more events, the UE could determine or identify
First current beam RS(s) or RS resource(s)—e.g., in terms/form the corresponding RS/resource index(es)/ID(s)—according to or based on RS(s) or RS resource(s) specific or associated or corresponding to a first TCI state associated/specific to the first CORESETs, i.e., coresetPoolIndex value 0; in this case, the first current beam RS(s) or RS resource(s) could be associated/specific to the first CORESETs, i.e., coresetPoolIndex value 0; and
Second current beam RS(s) or RS resource(s)—e.g., in terms/form the corresponding RS/resource index(es)/ID(s)—according to or based on RS(s) or RS resource(s) specific or associated or corresponding to a second TCI state associated/specific to the second CORESETs, i.e., coresetPoolIndex value 1; in this case, the second current beam RS(s) or RS resource(s) could be associated/specific to the second CORESETs, i.e., coresetPoolIndex value 1.

Throughout the present disclosure, a TCI state associated, specific or corresponding to a RS or RS resource (or vice versa) could correspond to or could be equivalent to or could be referred to/regarded as:
the RS or RS resource could correspond to a QCL source RS or RS resource e.g. a NZP CSI-RS resource or resource configuration provided or indicated in the TCI state; and/or
the RS or RS resource could correspond to a QCL root RS or RS resource e.g. a SSB quasi-co-located (QCL'ed)—e.g., of QCL-TypeD—with a RS or RS resource serving/configured as a QCL source RS e.g. a NZP CSI-RS resource or resource configuration provided or indicated in the TCI state.

Furthermore, a TCI state could be associated, specific or corresponding to a coresetPoolIndex value when/if:
the TCI state is mapped to a TCI codepoint activated or indicated by a (unified) TCI state(s) activation/deactivation MAC CE command associated, specific or corresponding to a coresetPoolIndex value—e.g., the coresetPoolIndex value could be comprised, provided or indicated in the (unified) TCI state(s) activation/deactivation MAC CE command; and/or
the TCI state is indicated by a TCI codepoint of a/the TCI field in a beam indication DCI, e.g., of DCI format(s) 1_1/1_2 with or without DL assignment, received in a CORESET associated or configured with the coresetPoolIndex value.

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, the UE could be configured or provided by the network, e.g., via higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation,
A first list/set/pool of N_1≥1 (higher layer configured) candidate beam RS(s) or RS resource(s) provided by CandidateBeamRSList1, e.g., in form/terms of the corresponding RS/resource ID(s)/index(es), wherein the first list/set/pool of candidate beam RS(s) or RS resource(s) could be configured with a first list/set/pool ID/index, and/or associated, mapped or linked to the first TCI state, and/or
A second list/set/pool of N_2≥1 (higher layer configured) candidate beam RS(s) or RS resource(s) provided by CandidateBeamRSList2, e.g., in form/terms of the corresponding RS/resource ID(s)/index(es), wherein the second list/set/pool of candidate beam RS(s) or RS resource(s) could be configured with a second list/set/pool ID/index, and/or associated, mapped or linked to the second TCI state,
   wherein a candidate beam RS or RS resource could correspond to a SSB or a NZP CSI-RS resource or resource configuration, N_1 could be the same as (or different from) N_2, the second list/set/pool ID/index could be different from (or identical to) the first list/set/pool ID/index, and the UE could determine or identify the aforementioned association(s), mapping(s) or linkage(s) according to or based on:
Fixe rule(s) in system specification(s) and/or per RRC (re-)configuration: for instance, the first list/set/pool ID/index could be lower (or higher) than the second list/set/pool ID/index, and/or the TCI state ID/index of the first TCI state could be lower (or higher) than that of the second TCI state; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters CandidateBeamRSList1 and CandidateBeamRSList1 could respectively comprise, contain, include, provide or configure TCI state ID/indexes of the first and second TCI states; for another example, the higher layer parameter TCI-State that provides or configures the first TCI state could comprise, contain, include, provide or configure the first list/set/pool ID/index, and the higher layer parameter TCI-State that provides or configures the second TCI state could comprise, contain, include, provide or configure the second list/set/pool ID/index; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on their ordinal positions/numbers, and the first and second TCI states according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on the cardinal (or ordinal) numbers/values of the first and second list/set/pool IDs/indexes, and TCI state IDs/indexes of the first and second TCI states according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on their respective first and second list/set/pool IDs/indexes from low to high (or high to low), and TCI state IDs/indexes of the first and second TCI states from low to high (or high to low); for another example, the UE could be provided or configured or indicated that the first list/set/pool ID/index is associated, corresponding or specific to the TCI state ID/index of the first TCI state, and the second list/set/pool ID/index is associated, corresponding or specific to the TCI state ID/index of the second TCI state; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

The UE could determine or identify the bit width of a candidate beam RS or RS resource ID/index as one or more of:
Method-1: ┌ log₂N_1┐ when/if the candidate beam RS or RS resource is in/from the first list/set/pool, and ┌ log₂N_2┐ when/if the candidate beam RS or RS resource is in/from the second list/set/pool;
Method-2: ┌ log₂(N_1+N_2)┐ regardless whether the candidate beam RS or RS resource is in/from the first or second list/set/pool, according to or based on network's configuration(s)/indication(s)/enabling(s) e.g. via higher layer RRC signaling(s)/parameter(s) and/or MAC CE command(s) and/or dynamic DCI based L1 signaling(s) based on or according to a corresponding UE's capability or capability signaling. For instance, when/if the UE is provided or configured with a higher layer parameter candidateBeamRsIndex set to ‘local’, the UE could follow, use or apply Method-1 to determine or identify the bit width of RS/resource ID(s)/index(es) of candidate beam RS(s) or RS resource(s); and/or when/if the UE is provided or configured with a higher layer parameter candidateBeamRsIndex set to ‘global’, the UE could follow, use or apply Method-2 to determine or identify the bit width of RS/resource ID(s)/index(es) of candidate beam RS(s) or RS resource(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, and/or when/if for a serving cell the UE is provided two coresetPoolIndex values 0 and 1 for first and second CORESETs, or is not provided coresetPoolIndex value for first CORESETs and is provided coresetPoolIndex value of 1 for second CORESETs,
The aforementioned first list/set/pool of N_1≥1 (higher layer configured) candidate beam RS(s) or RS resource(s) provided by CandidateBeamRSList1, e.g., in form/terms of the corresponding RS/resource ID(s)/index(es), and configured with the first list/set/pool ID/index, could be associated, mapped or linked to value 0 of coresetPoolIndex, and/or
The aforementioned second list/set/pool of N_2≥1 (higher layer configured) candidate beam RS(s) or RS resource(s) provided by CandidateBeamRSList1, e.g., in form/terms of the corresponding RS/resource ID(s)/index(es), and configured with the second list/set/pool ID/index, could be associated, mapped or linked to value 1 of coresetPoolIndex, wherein the UE could determine or identify the aforementioned association(s), mapping(s) or linkage(s) according to or based on:
Fixe rule(s) in system specification(s) and/or per RRC (re-)configuration: for instance, the first list/set/pool ID/index could be lower (or higher) than the second list/set/pool ID/index; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters CandidateBeamRSList1 and CandidateBeamRSList1 could respectively comprise, contain, include, provide or configure values 0 and 1 of coresetPoolIndex; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on their ordinal positions/numbers, and values of coresetPoolIndex according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on the cardinal (or ordinal) numbers/values of the first and second list/set/pool IDs/indexes, and values 0 and 1 of coresetPoolIndex according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second lists/sets/pools of candidate beam RSs/RS resources according to or based on their respective first and second list/set/pool IDs/indexes from low to high (or high to low), and values 0 and 1 of coresetPoolIndex from low to high (or high to low); for another example, the UE could be provided or configured or indicated that the first list/set/pool ID/index is associated, corresponding or specific to value 0 of coresetPoolIndex, and the second list/set/pool ID/index is associated, corresponding or specific to value 1 of coresetPoolIndex; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

According to or following those specified or defined herein in the present disclosure, a UE could determine or identify an instance of a first event (or an Event-1 instance) according to or based on:
Case-1: when/if the UE has determined or identified only the first current beam RS(s) or RS resource(s)—e.g., in terms/form the corresponding RS/resource index(es)/ID(s)—according to or based on the RS(s) or RS resource(s) specific or associated or corresponding to the first TCI state according to or following those specified or defined herein in the present disclosure, the UE could determine or identify that the beam quality(s)/metric(s)—e.g., measured L1-RSRP(s)/L1-SINR(s)—of the determined or identified first current beam RS(s) or RS resource(s) is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
Case-2: when/if the UE has determined or identified only the second current beam RS(s) or RS resource(s)—e.g., in terms/form the corresponding RS/resource index(es)/ID(s)—according to or based on the RS(s) or RS resource(s) specific or associated or corresponding to the second TCI state according to or following those specified or defined herein in the present disclosure, the UE could determine or identify that the beam quality(s)/metric(s)—e.g., measured L1-RSRP(s)/L1-SINR(s)—of the determined or identified second current beam RS(s) or RS resource(s) is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
Case-3: when/if the UE has determined or identified both the first and second current beam RSs or RS resources—e.g., in terms/form the corresponding RS/resource indexes/IDs—according to or based on the RSs or RS resources respectively specific or associated or corresponding to the first and second TCI states according to or following those specified or defined herein in the present disclosure,
   (Case-3.1) the UE could determine or identify that the beam quality(s)/metric(s)—e.g., measured L1-RSRP(s)/L1-SINR(s)—of the determined or identified first current beam RS(s) or RS resource(s) is below or less than or equal to a threshold; or
   (Case-3.2) the UE could determine or identify that the beam quality(s)/metric(s)—e.g., measured L1-RSRP(s)/L1-SINR(s)—of the determined or identified second current beam RS(s) or RS resource(s) is below or less than or equal to a threshold; or
   (Case-3.3) the UE could determine or identify that the (joint) beam quality(s)/metric(s)—e.g., measured and/or averaged and/or summed L1-RSRP(s)/L1-SINR(s)—of the determined or identified first and second current beam RSs or RS resources is below or less than or equal to a threshold.

The UE could determine or identify the threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Optionally, the UE could determine or identify which of the Case-3.1, Case-3.2 and Case-3.3 to follow for determining or identifying an Event-1 instance according to or based on: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, for the Case-3.3, the UE could determine or identify the (joint) beam quality(s)/metric(s)—e.g., in terms/form of (joint) L1-RSRP(s)/L1-SINR(s)—according to one or more of:
For example, the UE could first determine or identify the first beam quality(s)/metric(s)—e.g., measured L1-RSRP(s)/L1-SINR(s)—of the determined or identified first current beam RS(s) or RS resource(s), and the second beam quality(s)/metric(s)—e.g., measured L1-RSRP(s)/L1-SINR(s)—of the determined or identified second current beam RS(s) or RS resource(s); the UE could then determine or identify the (joint) beam quality(s)/metric(s) by: (1) summing up the first and second beam qualities/metrics, (2) by averaging over the first and second beam qualities/metrics, and/or etc.
For another example, the UE could determine or identify the (joint) beam quality(s)/metric(s) by assuming simultaneous reception/measuring of the first and second current beam RSs or RS resources.

According to or following those specified or defined herein in the present disclosure, a UE could determine or identify an instance of a second event (or an Event-2 instance) according to or based on:
Case-i: when/if the UE has determined or identified only the first current beam RS(s) or RS resource(s)—e.g., in terms/form the corresponding RS/resource index(es)/ID(s)—according to or based on the RS(s) or RS resource(s) specific or associated or corresponding to the first TCI state according to or following those specified or defined herein in the present disclosure,
   (Case-i.1) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(Case-i.2) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
(Case-i.3) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Optionally, the UE could determine or identify which of the Case-i.1, Case-i.2 and Case-i.3 to follow for determining or identifying an Event-2 instance according to or based on: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
Case-ii: when/if the UE has determined or identified only the second current beam RS(s) or RS resource(s)—e.g., in terms/form the corresponding RS/resource index(es)/ID(s)—according to or based on the RS(s) or RS resource(s) specific or associated or corresponding to the second TCI state according to or following those specified or defined herein in the present disclosure,
   (Case-ii.1) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-ii.2) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-ii.3) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Optionally, the UE could determine or identify which of the Case-ii.1, Case-ii.2 and Case-ii.3 to follow for determining or identifying an Event-2 instance according to or based on: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
Case-iii: when/if the UE has determined or identified both the first and second current beam RSs or RS resources—e.g., in terms/form the corresponding RS/resource indexes/IDs—according to or based on the RSs or RS resources respectively specific or associated or corresponding to the first and second TCI states according to or following those specified or defined herein in the present disclosure
   (Case-iii.1) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.2) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.3) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.4) the UE could determine or identify at least one (same) first candidate beam RS or RS resource from the first list/set/pool of candidate beam RS(s) or RS resource(s) and one (same) second candidate beam RS or RS resource from the second list/set/pool of candidate beam RS(s) or RS resource(s) that have (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—a threshold value greater than or equal to the beam quality(s)/metric(s)—e.g., measured L1-RSRP(s)/L1-SINR(s)—of the determined or identified first current beam RS(s) or RS resource(s) according to or following those specified herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.5) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.6) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.7) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.8) the UE could determine or identify at least one (same) first candidate beam RS or RS resource from the first list/set/pool of candidate beam RS(s) or RS resource(s) and one (same) second candidate beam RS or RS resource from the second list/set/pool of candidate beam RS(s) or RS resource(s) that have (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—a threshold value greater than or equal to the beam quality(s)/metric(s)—e.g., measured L1-RSRP(s)/L1-SINR(s)—of the determined or identified second current beam RS(s) or RS resource(s) according to or following those specified herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.9) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—of the determined or identified first and second current beam RSs or RS resources according to or following those specified herein in the present disclosure (e.g., those for the Case-3.3), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.10) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greaterthan or equal to the (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—of the determined or identified first and second current beam RSs or RS resources according to or following those specified herein in the present disclosure (e.g., those for the Case-3.3), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.11) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—of the determined or identified first and second current beam RSs or RS resources according to or following those specified herein in the present disclosure (e.g., those for the Case-3.3), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.12) the UE could determine or identify at least one (same) first candidate beam RS or RS resource from the first list/set/pool of candidate beam RS(s) or RS resource(s) and one (same) second candidate beam RS or RS resource from the second list/set/pool of candidate beam RS(s) or RS resource(s) that have (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—a threshold value greater than or equal to the (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—of the determined or identified first and second current beam RSs or RS resources according to or following those specified herein in the present disclosure (e.g., those for the Case-3.3), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.13) the UE could determine or identify at least one (same) candidate beam RS or RS resource from the first list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first and/or second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.14) the UE could determine or identify at least one (same) candidate beam RS or RS resource from the second list/set/pool of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first and/or second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.15) the UE could determine or identify at least one (same) candidate beam RS or RS resource from the first and/or second list(s)/set(s)/pool(s) of candidate beam RS(s) or RS resource(s) that has beam quality(s)/metric(s)—e.g., measured L1-RSRP(s)/L1-SINR(s)—a threshold value greater than or equal to the beam quality(s)/metric(s)—e.g., measured L1-RSRP(s)/L1-SINR(s)—of the determined or identified first and/or second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   (Case-iii.16) the UE could determine or identify at least one (same) first candidate beam RS or RS resource from the first list/set/pool of candidate beam RS(s) or RS resource(s) and one (same) second candidate beam RS or RS resource from the second list/set/pool of candidate beam RS(s) or RS resource(s) that have (joint) beam quality(s)/metric(s)—e.g., (joint) L1-RSRP(s)/L1-SINR(s) in terms/form of measured and/or averaged and/or summed L1-RSRP(s)/L1-SINR(s) e.g. obtained/measured assuming/for simultaneous reception(s)—a threshold value greater than or equal to the beam quality(s)/metric(s)—e.g., measured L1-RSRP(s)/L1-SINR(s)—of the determined or identified first and/or second current beam RS(s) or RS resource(s), wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Optionally, the UE could determine or identify which of the Case-iii.1-Case-iii.16 to follow for determining or identifying an Event-2 instance according to or based on: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified/defined herein in the present disclosure, (higher layer(s) of) a/the UE could declare, determine or detect the first event (or Event-1) when/if the number of the instance(s) of the first event (or the Event-1 instance(s)) determined or identified by (higher layer(s) of) the UE is greater than or equal to Q≥1 within a time window/duration of length M≥1, wherein the UE could determine or identify value(s) of Q and/or M based on or according to network's configuration(s)/indication(s) via/by higher layer RRC signaling(s)/parameter(s) and/or MAC CE command(s) and/or dynamic DCI based L1 signaling(s) based on or according to a corresponding UE's capability or capability signaling.

According to or following those specified/defined herein in the present disclosure, (higher layer(s) of) a/the UE could declare, determine or detect the second event (or Event-2) when/if the number of the instance(s) of the second event (or the Event-2 instance(s)) determined or identified by (higher layer(s) of) the UE is greater than or equal to Q≥1 within a time window/duration of length M≥1, wherein the UE could determine or identify value(s) of Q and/or M based on or according to network's configuration(s)/indication(s) via/by higher layer RRC signaling(s)/parameter(s) and/or MAC CE command(s) and/or dynamic DCI based L1 signaling(s) based on or according to a corresponding UE's capability or capability signaling.

In one operation mode (Mode A), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationld: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value Isym corresponds to 1 symbol, Value 2sym corresponds to 2 symbols, and so on; Value 1 sl corresponds to 1 slot, Value 2 sl corresponds to 2 slots, and so on; Value msI corresponds to 1 ms, value ms2 corresponds to 2 ms, and so on. Ifpn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k i, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k i, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-51: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-51, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationld: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value Isym corresponds to 1 symbol, Value 2sym corresponds to 2 symbols, and so on; Value 1 sl corresponds to 1 slot, Value 2 sl corresponds to 2 slots, and so on; Value msl corresponds to 1 ms, value ms2 corresponds to 2 ms, and so on. Ifpn-ProhibitTimer is absent, the UE could apply the value 0.
pn-TransMax: a maximum number of PN (or SR) transmissions. Value n4 corresponds to 4, value n8 corresponds to 8, and so on.
periodicityAndOffset: PN (or SR) periodicity and offset in number of symbols or slots. The periodicity(s) could be configured or provided depending on the chose subcarrier spacing.
Phy-PriorityIndex: indicate whether this PN (or SR) resource (i.e., the first PUCCH resource) is high or low priority in PHY prioritization/multiplexing handling. Value p0 indicates low priority and value p1 indicates high priority.
resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., tI=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationld: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1 sl corresponds to 1 slot, Value 2 sl corresponds to 2 slots, and so on; Value msI corresponds to 1 ms, value ms2 corresponds to 2 ms, and so on. Ifpn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger—in this case, the DCI could also be regarded/referred to as a NWR. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, whether or not the UE could expect to receive from the network the (downlink/uplink) DCI in response to the PN message/trigger. The (downlink/uplink) DCI in response to the PN message/trigger could comprise one or more of the following components:
   Component-i: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k i, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-51: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bit width k of a resource ID/index could be determined or calculated or computed with respect to a number of resources (denoted by K) in a resource set such that k=└ log₂K┘ or k=┌ log₂K┐. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) all (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k i, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state sub-selection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined above, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in vanous UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/triggertransmission does not indicate, provide or comprise component(s) related to dynamic scheduling of resource(s) such as Component-5g, Component-51, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-51, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is ql (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-)configured by the network for transmitting or sending the UEI report content(s)/quantity(s) as defined or specified herein in the present disclosure, the UE could (always) determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-I—Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}; {Mode B}; {Mode C}; {Mode A, Mode B}; {Mode A, Mode C}; and {Mode B, Mode C}

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, for Mode A, Mode B and/or Mode C, the UE could be configured or provided by the network, e.g., via higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation,
A first PUCCH resource configuration with (or in terms/form of) a first PUCCH resource configuration ID/index having/comprising one or more candidate PUCCH resources (e.g., in terms/form of their corresponding PUCCH resource IDs/indexes) for transmitting or sending PN message(s)/trigger(s) in the first UL channel as specified/defined herein in the present disclosure, and/or associated, mapped or linked to the first TCI state, and/or
A second PUCCH resource configuration (or in terms/form of) with a second PUCCH resource configuration ID/index having/comprising one or more candidate PUCCH resources (e.g., in terms/form of their corresponding PUCCH resource IDs/indexes) for transmitting or sending PN message(s)/trigger(s) in the first UL channel as specified/defined herein in the present disclosure, and/or associated, mapped or linked to the second TCI state,
   wherein the second PUCCH resource configuration ID/index could be different from (or identical to) the first PUCCH resource configuration ID/index, and the UE could determine or identify the aforementioned association(s), mapping(s) or linkage(s) according to or based on:
Fixe rule(s) in system specification(s) and/or per RRC (re-)configuration: for instance, the first PUCCH resource configuration ID/index could be lower (or higher) than the second PUCCH resource configuration ID/index, and/or the TCI state ID/index of the first TCI state could be lower (or higher) than that of the second TCI state; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters that provides or configures the first and second PUCCH resource configurations could respectively comprise, contain, include, provide or configure TCI state ID/indexes of the first and second TCI states; for another example, the higher layer parameter TCI-State that provides or configures the first TCI state could comprise, contain, include, provide or configure the first PUCCH resource configuration ID/index, and the higher layer parameter TCI-State that provides or configures the second TCI state could comprise, contain, include, provide or configure the second PUCCH resource configuration ID/index; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on their ordinal positions/numbers, and the first and second TCI states according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on the cardinal (or ordinal) numbers/values of the first and second PUCCH resource configuration IDs/indexes, and TCI state IDs/indexes of the first and second TCI states according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on their respective first and second PUCCH resource configuration IDs/indexes from low to high (or high to low), and TCI state IDs/indexes of the first and second TCI states from low to high (or high to low); for another example, the UE could be provided or configured or indicated that the first PUCCH resource configuration ID/index is associated, corresponding or specific to the TCI state ID/index of the first TCI state, and the second PUCCH resource configuration ID/index is associated, corresponding or specific to the TCI state ID/index of the second TCI state; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, and/or when/if for a serving cell the UE is provided two coresetPoolIndex values 0 and 1 for first and second CORESETs, or is not provided coresetPoolIndex value for first CORESETs and is provided coresetPoolIndex value of 1 for second CORESETs, for Mode A, Mode B and/or Mode C,
The aforementioned first PUCCH resource configuration with (or in terms/form of) the first PUCCH resource configuration ID/index, could be associated, mapped or linked to value 0 of coresetPoolIndex, and/or
The aforementioned second PUCCH resource configuration with (or in terms/form of) the second PUCCH resource configuration ID/index, could be associated, mapped or linked to value 1 of coresetPoolIndex, wherein the UE could determine or identify the aforementioned association(s), mapping(s) or linkage(s) according to or based on:
Fixe rule(s) in system specification(s) and/or per RRC (re-)configuration: for instance, the first PUCCH resource configuration ID/index could be lower (or higher) than the second PUCCH resource configuration ID/index; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters that provides or configures the first and second PUCCH resource configurations could respectively comprise, contain, include, provide or configure values 0 and 1 of coresetPoolIndex; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on their ordinal positions/numbers, and values of coresetPoolIndex according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on the cardinal (or ordinal) numbers/values of the first and second PUCCH resource configuration IDs/indexes, and values 0 and 1 of coresetPoolIndex according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUCCH resource configurations (hence the PUCCH resource(s) in terms/form of the corresponding PUCCH resource ID(s)/index(es) therein) according to or based on their respective first and second PUCCH resource configuration IDs/indexes from low to high (or high to low), and values 0 and 1 of coresetPoolIndex from low to high (or high to low); for another example, the UE could be provided or configured or indicated that the first PUCCH resource configuration ID/index is associated, corresponding or specific to value 0 of coresetPoolIndex, and the second PUCCH resource configuration ID/index is associated, corresponding or specific to value 1 of coresetPoolIndex; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, for at least Mode B, the UE could be configured or provided by the network, e.g., via higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation,
A first PUSCH resource configuration with (or in terms/form of) a first PUSCH resource configuration ID/index having/comprising one or more candidate PUSCH resources (e.g., in terms/form of their corresponding PUSCH resource IDs/indexes) for transmitting or sending UEI report content(s)/quantity(s) in the second UL channel as specified/defined herein in the present disclosure, and/or associated, mapped or linked to the first TCI state, and/or
A second PUSCH resource configuration (or in terms/form of) with a second PUSCH resource configuration ID/index having/comprising one or more candidate PUSCH resources (e.g., in terms/form of their corresponding PUSCH resource IDs/indexes) for transmitting or sending UEI report content(s)/quantity(s) in the second UL channel as specified/defined herein in the present disclosure, and/or associated, mapped or linked to the second TCI state,
   wherein the second PUSCH resource configuration ID/index could be different from (or identical to) the first PUSCH resource configuration ID/index, and the UE could determine or identify the aforementioned association(s), mapping(s) or linkage(s) according to or based on:
Fixe rule(s) in system specification(s) and/or per RRC (re-)configuration: for instance, the first PUSCH resource configuration ID/index could be lower (or higher) than the second PUSCH resource configuration ID/index, and/or the TCI state ID/index of the first TCI state could be lower (or higher) than that of the second TCI state; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters that provides or configures the first and second PUSCH resource configurations could respectively comprise, contain, include, provide or configure TCI state ID/indexes of the first and second TCI states; for another example, the higher layer parameter TCI-State that provides or configures the first TCI state could comprise, contain, include, provide or configure the first PUSCH resource configuration ID/index, and the higher layer parameter TCI-State that provides or configures the second TCI state could comprise, contain, include, provide or configure the second PUSCH resource configuration ID/index; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their ordinal positions/numbers, and the first and second TCI states according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on the cardinal (or ordinal) numbers/values of the first and second PUSCH resource configuration IDs/indexes, and TCI state IDs/indexes of the first and second TCI states according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their respective first and second PUSCH resource configuration IDs/indexes from low to high (or high to low), and TCI state IDs/indexes of the first and second TCI states from low to high (or high to low); for another example, the UE could be provided or configured or indicated that the first PUSCH resource configuration ID/index is associated, corresponding or specific to the TCI state ID/index of the first TCI state, and the second PUSCH resource configuration ID/index is associated, corresponding or specific to the TCI state ID/index of the second TCI state; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, for at least Mode B, the UE could be configured or provided by the network, e.g., via higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation,
A first PUSCH resource configuration with (or in terms/form of) a first PUSCH resource configuration ID/index having/comprising one or more candidate PUSCH resources (e.g., in terms/form of their corresponding PUSCH resource IDs/indexes) for transmitting or sending UEI report content(s)/quantity(s) in the second UL channel as specified/defined herein in the present disclosure, and/or associated, mapped or linked to the first PUCCH resource configuration, and/or
A second PUSCH resource configuration (or in terms/form of) with a second PUSCH resource configuration ID/index having/comprising one or more candidate PUSCH resources (e.g., in terms/form of their corresponding PUSCH resource IDs/indexes) for transmitting or sending UEI report content(s)/quantity(s) in the second UL channel as specified/defined herein in the present disclosure, and/or associated, mapped or linked to the second PUCCH resource configuration,
   wherein the second PUSCH resource configuration ID/index could be different from (or identical to) the first PUSCH resource configuration ID/index, and the UE could determine or identify the aforementioned association(s), mapping(s) or linkage(s) according to or based on:
Fixe rule(s) in system specification(s) and/or per RRC (re-)configuration: for instance, the first PUSCH resource configuration ID/index could be lower (or higher) than the second PUSCH resource configuration ID/index, and/or the first PUCCH resource configuration ID/index could be lower (or higher) than the second PUCCH resource configuration ID/index; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters that provides or configures the first and second PUSCH resource configurations could respectively comprise, contain, include, provide or configure the first and second PUCCH resource configuration IDs/indexes; for another example, the higher layer parameters that provides or configures the first and second PUCCH resource configurations could respectively comprise, contain, include, provide or configure the first and second PUSCH resource configuration IDs/indexes; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their ordinal positions/numbers, and the first and second PUCCH resource configurations (hence the PUCCH resource(s) in terms/form of the corresponding PUCCH resource ID(s)/index(es) therein) according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on the cardinal (or ordinal) numbers/values of the first and second PUSCH resource configuration IDs/indexes, and the first and second PUCCH resource configurations (hence the PUCCH resource(s) in terms/form of the corresponding PUCCH resource ID(s)/index(es) therein) according to or based on the cardinal (or ordinal) numbers/values of the first and second PUCCH resource configuration IDs/indexes; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their respective first and second PUSCH resource configuration IDs/indexes from low to high (or high to low), and the first and second PUCCH resource configurations (hence the PUCCH resource(s) in terms/form of the corresponding PUCCH resource ID(s)/index(es) therein) according to or based on their respective first and second PUCCH resource configuration IDs/indexes from low to high (or high to low); for another example, the UE could be provided or configured or indicated that the first PUSCH resource configuration ID/index is associated, corresponding or specific to first PUCCH resource configuration ID/index, and the second PUSCH resource configuration ID/index is associated, corresponding or specific to the second PUCCH resource configuration ID/index; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

When/if a UE is enabled by the network (e.g., via/by higher layer RRC signaling(s)/parameter(s) and/or MAC CE command(s) and/or dynamic DCI based L1 signaling(s) based on or according to corresponding UE's capability(s)/capability signaling(s)) to perform or conduct UE-initiated/event-driven beam management including beam reporting for multi-TRP operation, and/or when/if for a serving cell the UE is provided two coresetPoolIndex values 0 and 1 for first and second CORESETs, or is not provided coresetPoolIndex value for first CORESETs and is provided coresetPoolIndex value of 1 for second CORESETs, for Mode A, Mode B and/or Mode C,
The aforementioned first PUSCH resource configuration with (or in terms/form of) the first PUSCH resource configuration ID/index, could be associated, mapped or linked to value 0 of coresetPoolIndex, and/or
The aforementioned second PUSCH resource configuration with (or in terms/form of) the second PUSCH resource configuration ID/index, could be associated, mapped or linked to value 1 of coresetPoolIndex,
   wherein the UE could determine or identify the aforementioned association(s), mapping(s) or linkage(s) according to or based on:
Fixe rule(s) in system specification(s) and/or per RRC (re-)configuration: for instance, the first PUSCH resource configuration ID/index could be lower (or higher) than the second PUSCH resource configuration ID/index; and/or
Network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling: for example, the higher layer parameters that provides or configures the first and second PUSCH resource configurations could respectively comprise, contain, include, provide or configure values 0 and 1 of coresetPoolIndex; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their ordinal positions/numbers, and values of coresetPoolIndex according to or based on their ordinal positions/numbers; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on the cardinal (or ordinal) numbers/values of the first and second PUSCH resource configuration IDs/indexes, and values 0 and 1 of coresetPoolIndex according to or based on their cardinal (or ordinal) numbers/values; for another example, the higher layer RRC signaling(s)/parameter(s) CSI-ReportConfig and/or UEI-ReportConfig and/or CSI-ResourceConfig/UEI-ResourceConfig linked or associated or corresponding to CSI-ReportConfig/UEI-ReportConfig that may provide or configure necessary information and/or reporting/resource setting(s) for the UE-initiated/event-driven beam management including beam reporting for the multi-TRP operation could provide or configure or comprise or contain or include the first and second PUSCH resource configurations (hence the PUSCH resource(s) in terms/form of the corresponding PUSCH resource ID(s)/index(es) therein) according to or based on their respective first and second PUSCH resource configuration IDs/indexes from low to high (or high to low), and values 0 and 1 of coresetPoolIndex from low to high (or high to low); for another example, the UE could be provided or configured or indicated that the first PUSCH resource configuration ID/index is associated, corresponding or specific to value 0 of coresetPoolIndex, and the second PUSCH resource configuration ID/index is associated, corresponding or specific to value 1 of coresetPoolIndex; and/or
UE's implementations, and/or UE's autonomous determination(s) and/or selection(s), which could be further sent or transmitted or indicated to the network via/by/in various UL channels and/or signals including CSI/beam report(s) and/or UE's capability signaling(s).

For Mode A, Mode B and/or Mode C as specified/defined herein in the present disclosure, the UE could determine or identify which of the first and second PUCCH resource configurations to use for determining or identifying the PUCCH resource(s) of the first UL channel to carry or convey the PN message(s)/trigger(s) as in Step-I of Mode A, Mode B and/or Mode C according to or based on: fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For at least Mode B as specified/defined herein in the present disclosure, the UE could determine or identify which of the first and second PUSCH resource configurations to use for determining or identifying the PUSCH resource(s) of the second UL channel to carry or convey the UE report content(s)/quantity(s) as in Step-2 of Mode B according to or based on: fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For Mode A, Mode B and/or Mode C as specified/defined herein in the present disclosure, a PN message/trigger could correspond to or could be equivalent to or could be replaced by/with or could be used in an exchangeable manner with transmission of a PN message/trigger, a PN message/trigger transmission, a PN message/trigger transmission occasion, a PUCCH resource of the first UL channel, a PN message/trigger transmission (occasion) via/in/by a PUCCH resource of the first UL channel and/or etc. throughout the present disclosure; and/or, UEI report content(s)/quantity(s) could correspond to or could be equivalent to or could be replaced by/with or could be used in an exchangeable manner with transmission of UEI report content(s)/quantity(s), UEI report content(s)/quantity(s) transmission, UEI report content(s)/quantity(s) transmission occasion, a PUSCH resource of the second UL channel, UEI report content(s)/quantity(s) transmission (occasion) via/in/by a PUSCH resource of the second UL channel and/or etc. throughout the present disclosure. For instance, UEI report content(s)/quantity(s) associated/specific to a PN message/trigger could be equivalent to a PUSCH resource of the second UL channel that carries or conveys the UEI report content(s)/quantity(s) associated/specific to a PUCCH resource of the first UL channel that carries or conveys the PN message/trigger, and/or UEI report content(s)/quantity(s) transmission occasion of a PUSCH resource of the second UL channel associated/specific to a/the PN message/trigger transmission occasion of a PUCCH resource of the first UL channel. Throughout the present disclosure, a PN message/trigger could also be referred to as a UEI transmission indication/indicator (UEITI), which could be a UCI type/parameter similar to HARQ-ACK, CSI and/or etc.

Throughout the present disclosure, a PN message/trigger as specified/defined herein in the present disclosure (e.g., in both Mode A and Mode B) could be associated to one or more CSI reporting settings each provided by CSI-ReportConfig or UEI-ReportConfig. The UE could determine or identify the association according to or based on: fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s). For instance, a/the first PN message/trigger as specified/defined herein in the present disclosure could be associated to a first CSI reporting setting provided by CSI-ReportConfig (with a first reportConfigId), and a/the second PN message/trigger as specified/defined herein in the present disclosure could be associated to a second CSI reporting setting provided by CSI-ReportConfig (with a second reportConfigId), wherein the first reportConfigId could be identical to/the same as or different/separate from the second reportConfigId. In this case, the UE could determine or identify UL resource(s)/occasion(s) for transmitting a/the first (UEI) beam report triggered or indicated by the first PN message/trigger according to or following those specified herein in the present disclosure based on or according to the information and/or setting(s) and/or parameter(s) provided or configured in the first CSI reporting setting, and/or the UE could determine or identify UL resource(s)/occasion(s) for transmitting a/the second (UEI) beam report triggered or indicated by the second PN message/trigger according to or following those specified herein in the present disclosure based on or according to the information and/or setting(s) and/or parameter(s) provided or configured in the second CSI reporting setting. Furthermore, a NWR could be associated or corresponding or specific to a NWR ID such that the higher layer parameter(s)/signaling(s) that provides or configures the NWR (e.g., TCI-State that configures or provides a TCI state) could comprise, include, contain, provide or configure the corresponding NWR ID (e.g., a TCI State ID/index)—or equivalently, a configuration ID/index value could be provided or configured or comprised or included or contained in higher layer parameter(s)/signaling(s) that provides or configures a NWR (e.g., TCI-State that configures or provides a TCI state), and in this case, the configuration ID/index could be regarded/referred to as a/the NWR ID associated, specific, corresponding or linked to the NWR.

Throughout the present disclosure, transmitting or transmission(s) of or re-transmission(s) of a PUCCH of the first UL channel as in Step-1 of Mode A, Mode B and/or Mode C according to or following those specified/defined herein in the present disclosure could be equivalent to transmitting or transmission(s) of or re-transmission(s) of a PN message/trigger over/in/by a PUCCH resource of the first UL channel as in Step-1 of Mode A, Mode B and/or Mode C according to or following those specified/defined herein in the present disclosure. Similarly, transmitting, transmission(s) of or re-transmission(s) of beam report(s), e.g., the UEI beam report(s) as specified/defined herein in the present disclosure, via/by/in (DG or CG) PUSCH resource(s) of the second UL channel as in Step-2 of Mode B and/or Step-3 of Mode A and/or Mode C according to or following those specified/defined herein in the present disclosure is equivalent to transmitting, transmission(s) of or re-transmission(s) of PUSCH(s) or PUSCH resource(s) of the second UL channel as in Step-2 of Mode B and/or Step-3 of Mode A and/or Mode C carrying beam report(s), e.g., the UEI beam report(s) as specified/defined herein in the present disclosure, according to or following those specified/defined herein in the present disclosure. The UE could be provided or configured by the network, e.g., via higher layer RRC signalling(s)/parameter(s) e.g. frstPUCCHResourceConfig-UEIBR, a configuration for PUCCH transmission of the first UL channel as in Step-1 of Mode A, Mode B and/or Mode C with a/the report notification (RN) or report resource request (RRR), wherein a/the RN or RRR could be of a UCI type/parameter. Furthermore, the UE could be provided or configured by the network, e.g., via higher layer RRC signalling(s)/parameter(s) e.g. secondPUSCHResourceConfig-UEIBR, a configuration for PUSCH transmission of the second UL channel as in Step-2 of Mode B.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc. A/the higher layer parameter CSI-ReportConfig and/or UEI-ReportConfig could correspond to or could be equivalent to or referred to a/the higher layer parameter CSI-AssociatedReportConfigInfo, and vice versa, such that they could be used or applied exchangeably or in similar/same manner(s) throughout the present disclosure. Additionally, a CSI reporting setting not (dedicated) for the UE-initiated/event-driven beam reporting as specified/defined herein in the present disclosure could correspond to or could be equivalent to or could be referred to a CSI reporting setting for (legacy) aperiodic CSI/beam reporting or a CSI reporting setting for L1/L2 triggered mobility (LTM), and vice versa. In addition, a CSI reporting setting corresponding to another CSI reporting setting could be equivalent to the CSI reporting setting comprising, containing, including and/or providing the another CSI reporting setting.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a CSI report setting/CSI report configuration is equivalent to a CSI reporting setting/CSI reporting configuration and vice versa.

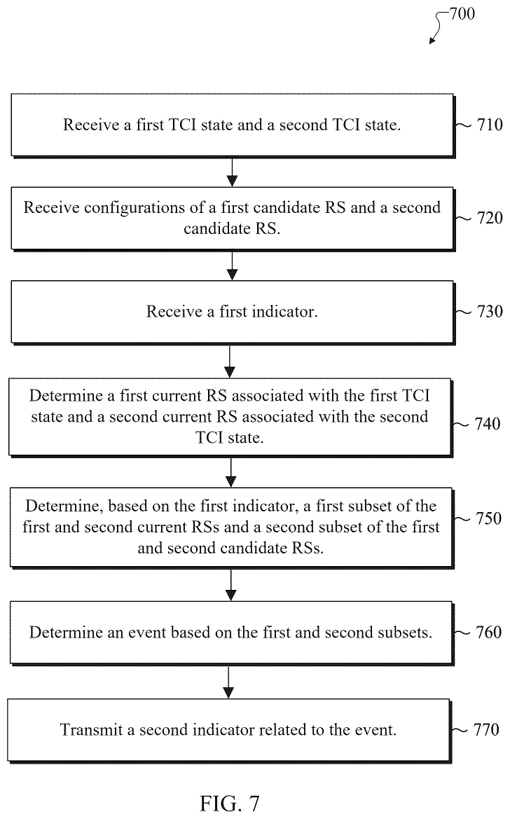

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method begins with the UE receiving a first TCI state and a second TCI state (710). In various embodiments, the first and second TCI states are mapped to a same TCI codepoint or associated with a first CORESET and a second CORESET, respectively. The first and second CORESETs are with values 0 and 1 of coresetPoolIndex, respectively. The UE then receives configurations of a first candidate RS and a second candidate RS (720). In various embodiments, the first candidate RS is a SS/PBCH block or a NZP CSI-RS, the second candidate RS is a SS/PBCH block or a NZP CSI-RS, and the configurations are provided by higher layer signaling. The UE then receives a first indicator (730). In various embodiments, when the first indicator is provided by higher layer signaling, the first indicator indicates ‘first’, ‘second’ or ‘both’. When the first indicator is indicated in a DCI, the first indicator is a 2-bit indicator.

The UE then determines a first current RS associated with the first TCI state and a second current RS associated with the second TCI state (740). In various embodiments, when the first candidate RS is a SS/PBCH block, the first current RS corresponds to a SS/PBCH block quasi-co-located with a RS in the first TCI state, and when the first candidate RS is a NZP CSI-RS, the first current RS corresponds to a RS in the first TCI state. When the second candidate RS is a SS/PBCH block, the second current RS corresponds to a SS/PBCH block quasi-co-located with a RS in the second TCI state, and when the second candidate RS is a NZP CSI-RS, the second current RS corresponds to a RS in the second TCI state.

The UE then determines, based on the first indicator, a first subset of the first and second current RSs and a second subset of the first and second candidate RSs (750). In various embodiments, when the first indicator is set to ‘first’ or ‘00’, the first subset includes the first current RS, and the second subset includes the first candidate RS. When the first indicator is set to ‘second’ or ‘01’, the first subset includes the second current RS, and the second subset includes the second candidate RS. When the first indicator is set to ‘both’ or ‘10’, the first subset includes the first and second current RSs, and the second subset includes the first and second candidate RSs. The first indicator may be signaled to the UE via DCI or MAC CE. In one embodiment, the indicator may further indicate a time duration or time interval during which at least one of the current and/or candidate RSs are active/activated. Alternatively, the time duration or time interval during which at least of the current and/or candidate RSs is active or activated may be indicated separately from the first indicator via DCI or MAC CE.

The UE then determines an event based on the first and second subsets (760). In one embodiment, the UE may determine an event based on the active/activated current or candidate RSs. The UE then transmits a second indicator related to the event (770). In various embodiments, an instance of the event is related to comparing measurements of the first subset and the second subset with a threshold. The second indicator is a one-bit indicator transmitted on a PUCCH resource. The threshold is higher layer configured.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a first transmission configuration indication (TCI) state and a second TCI state;
receive configurations of a first candidate reference signal (RS) and a second candidate RS; and
receive a first indicator; and
a processor operably coupled with the transceiver, the processor configured to:
determine a first current RS associated with the first TCI state and a second current RS associated with the second TCI state;
determine, based on the first indicator, a first subset of the first and second current RSs and a second subset of the first and second candidate RSs; and
determine an event based on the first and second subsets,
wherein the transceiver is further configured to transmit a second indicator related to the event.

2. The UE of claim 1, wherein the first and second TCI states are:
mapped to a same TCI codepoint; or
associated with a first control resource set (CORESET) and a second CORESET, respectively, wherein the first and second CORESETs are with values 0 and 1 of coresetPoolIndex, respectively.

3. The UE of claim 1, wherein:
the first candidate RS is a synchronization signal/physical broadcast channel (SS/PBCH) block or a non-zero-power channel state information reference signal (NZP CSI-RS);
the second candidate RS is a SS/PBCH block or a NZP CSI-RS; and
the configurations are provided by higher layer signaling.

4. The UE of claim 1, wherein:
when the first indicator is provided by higher layer signaling, the first indicator indicates ‘first’, ‘second’ or ‘both’; and
when the first indicator is indicated in a downlink control information (DCI), the first indicator is a 2-bit indicator.

5. The UE of claim 1, wherein:
when the first candidate RS is a synchronization signal/physical broadcast channel (SS/PBCH) block, the first current RS corresponds to a SS/PBCH block quasi-co-located with a RS in the first TCI state,
when the first candidate RS is a non-zero-power channel state information reference signal (NZP CSI-RS), the first current RS corresponds to a RS in the first TCI state,
when the second candidate RS is a SS/PBCH block, the second current RS corresponds to a SS/PBCH block quasi-co-located with a RS in the second TCI state, and
when the second candidate RS is a NZP CSI-RS, the second current RS corresponds to a RS in the second TCI state.

6. The UE of claim 1, wherein:
when the first indicator is set to ‘first’ or ‘00’, the first subset includes the first current RS, and the second subset includes the first candidate RS;
when the first indicator is set to ‘second’ or ‘01’, the first subset includes the second current RS, and the second subset includes the second candidate RS; and
when the first indicator is set to ‘both’ or ‘10’, the first subset includes the first and second current RSs, and the second subset includes the first and second candidate RSs.

7. The UE of claim 1, wherein:
an instance of the event is related to comparing measurements of the first subset and the second subset with a threshold;
the second indicator is a one-bit indicator transmitted on a physical uplink control channel (PUCCH) resource, and
the threshold is higher layer configured.

8. A base station (BS), comprising:
a processor; and
a transceiver operably coupled with the processor, the transceiver configured to:
transmit a first transmission configuration indication (TCI) state and a second TCI state, wherein a first current reference signal (RS) is associated with the first TCI state and a second current RS is associated with the second TCI state;
transmit configurations of a first candidate RS and a second candidate RS; and
transmit a first indicator, wherein the first indicator indicates a first subset of the first and second current RSs and a second subset of the first and second candidate RSs; and
receive a second indicator related to an event, wherein the event is based on the first and second subsets.

9. The BS of claim 8, wherein the first and second TCI states are:
mapped to a same TCI codepoint; or
associated with a first control resource set (CORESET) and a second CORESET, respectively, wherein the first and second CORESETs are with values 0 and 1 of coresetPoolIndex, respectively.

10. The BS of claim 8, wherein:
the first candidate RS is a synchronization signal/physical broadcast channel (SS/PBCH) block or a non-zero-power channel state information reference signal (NZP CSI-RS);
the second candidate RS is a SS/PBCH block or a NZP CSI-RS; and
the configurations are provided by higher layer signaling.

11. The BS of claim 8, wherein:
when the first indicator is provided by higher layer signaling, the first indicator indicates ‘first’, ‘second’ or ‘both’; and
when the first indicator is indicated in a downlink control information (DCI), the first indicator is a 2-bit indicator.

12. The BS of claim 8, wherein:
when the first candidate RS is a synchronization signal/physical broadcast channel (SS/PBCH) block, the first current RS corresponds to a SS/PBCH block quasi-co-located with a RS in the first TCI state,
when the first candidate RS is a non-zero-power channel state information reference signal (NZP CSI-RS), the first current RS corresponds to a RS in the first TCI state,
when the second candidate RS is a SS/PBCH block, the second current RS corresponds to a SS/PBCH block quasi-co-located with a RS in the second TCI state, and
when the second candidate RS is a NZP CSI-RS, the second current RS corresponds to a RS in the second TCI state.

13. The BS of claim 8, wherein:
when the first indicator is set to ‘first’ or ‘00’, the first subset includes the first current RS, and the second subset includes the first candidate RS;
when the first indicator is set to ‘second’ or ‘01’, the first subset includes the second current RS, and the second subset includes the second candidate RS; and
when the first indicator is set to ‘both’ or ‘10’, the first subset includes the first and second current RSs, and the second subset includes the first and second candidate RSs.

14. The BS of claim 8, wherein:
an instance of the event is related to comparison of measurements of the first subset and the second subset with a threshold;
the second indicator is a one-bit indicator received on a physical uplink control channel (PUCCH) resource, and
the threshold is higher layer configured.

15. A method performed by a user equipment (UE), the method comprising:
receiving a first transmission configuration indication (TCI) state and a second TCI state;
receiving configurations of a first candidate reference signal (RS) and a second candidate RS;
receiving a first indicator;
determining a first current RS associated with the first TCI state and a second current RS associated with the second TCI state;
determining, based on the first indicator, a first subset of the first and second current RSs and a second subset of the first and second candidate RSs;
determining an event based on the first and second subsets; and
transmitting a second indicator related to the event.

16. The method of claim 15, wherein the first and second TCI states are:
mapped to a same TCI codepoint; or
associated with a first control resource set (CORESET) and a second CORESET, respectively, wherein the first and second CORESETs are with values 0 and 1 of coresetPoolIndex, respectively.

17. The method of claim 15, wherein:
the first candidate RS is a synchronization signal/physical broadcast channel (SS/PBCH) block or a non-zero-power channel state information reference signal (NZP CSI-RS);
the second candidate RS is a SS/PBCH block or a NZP CSI-RS; and
the configurations are provided by higher layer signaling.

18. The method of claim 15, wherein:
when the first indicator is provided by higher layer signaling, the first indicator indicates ‘first’, ‘second’ or ‘both’; and
when the first indicator is indicated in a downlink control information (DCI), the first indicator is a 2-bit indicator.

19. The method of claim 15, wherein:
when the first candidate RS is a synchronization signal/physical broadcast channel (SS/PBCH) block, the first current RS corresponds to a SS/PBCH block quasi-co-located with a RS in the first TCI state,
when the first candidate RS is a non-zero-power channel state information reference signal (NZP CSI-RS), the first current RS corresponds to a RS in the first TCI state,
when the second candidate RS is a SS/PBCH block, the second current RS corresponds to a SS/PBCH block quasi-co-located with a RS in the second TCI state, and
when the second candidate RS is a NZP CSI-RS, the second current RS corresponds to a RS in the second TCI state.

20. The method of claim 15, wherein:
when the first indicator is set to ‘first’ or ‘00’, the first subset includes the first current RS, and the second subset includes the first candidate RS;
when the first indicator is set to ‘second’ or ‘01’, the first subset includes the second current RS, and the second subset includes the second candidate RS; and
when the first indicator is set to ‘both’ or ‘10’, the first subset includes the first and second current RSs, and the second subset includes the first and second candidate RSs.
